(19) United States
(12) Patent Application Publication
(10) Pub. No.: US 2026/0196123 A1
(43) Pub. Date: Jul. 9, 2026

(54) METHOD FOR DETECTING AN EVENT OR A SITUATION SUCH AS AN ATTACK

(71) Applicant: Conextivity Group SA, Saint-Prex (CH)

(72) Inventors: Adriana Arza, La-Tour-de-Peilz (CH); Alvaro Gonçalves, Rances (CH); Phong Pham, Le-Mont-sur-Lausanne (CH); Numa Piot, Lausanne (CH); Sakura Nussbaum, Le Mont-Pèlerin (CH); Mathieu Fivaz, Aubonne (CH)

(73) Assignee: Conextivity Group SA, Saint-Prex (CH)

(21) Appl. No.: 19/134,414

(22) PCT Filed: Nov. 24, 2023
(86) PCT No.: PCT/IB2023/061882

§ 371 Date: May 30, 2025

(30) Foreign Application Priority Data
Dec. 1, 2022 (EP) 22210863.1

(51) Int. Cl. G08B 25/01

(52) U.S. Cl. CPC G08B 25/016

(57) ABSTRACT

The present invention concerns a method for detecting an event or a situation happening around of at least a user, for example a valuable goods conveyor, wherein said method comprises the steps of —) measuring values of personal parameters linked to the user body and/or of environmental parameters linked to the environment of the user, —) analyzing the values obtained by the measurement step to predetermined patterns, trends of and/or ranges of values in time, —) depending on the result of the analysis, determining whether the measured values correspond to predetermined indicators of the event; wherein said indicators comprise at least first class indicators indicating high probability of the occurrence of an event and second class indicators indicating lower probability of the occurrence of an event.

### CORRESPONDING APPLICATIONS

The present is a national phase of international patent application PCT/IB/2023/061882 of 24 Nov. 2023, which claims priority to the earlier European patent application N° EP22210863.1, filed on Dec. 1, 2022 in the name of CONEXTIVITY GROUP SA, the content of the earlier application being incorporated by reference in its entirety in the present PCT application.

### TECHNICAL FIELD

The present invention concerns the field of methods for detecting an event or a situation such as an attack and devices suitable for such methods.

More specifically, the present invention concerns, in particular but not exclusively, the field of valuable goods and cash transport and the methods that can be used to protect and help conveyors in case of an attack.

### BACKGROUND ART

Despite the fact that electronic payment means and other technical means for this purpose (such as credit or debit cards, payments by phone) are increasingly used, a lot of cash money is still transported with vehicles and this cash money is the aim of people with bad intentions.

Although specific technical means have been used to protect bank notes and similar products (for example systems where stolen banknotes are marked with a specific ink when the container in which they are transported undergoes a forced opening), cash conveyors are one of the weak spots in cash transport security, so that detecting attacks on a robbery intent to cash conveyors in a quick a certain way is a long felt need in the cash transport industry. Moreover, it has been determined that more than 95% of the attacks happen when the conveyors are outside the vehicle at a collection/delivery area. However, the attack can also be carried out on a moving vehicle that is forced to stop or to take a different route than the one planned.

During a real attack, cash conveyors will experience extreme panic or fear, which triggers a body response to enhance the capacity of the conveyor to avoid an attack—fight or flight, commonly known as stress response; and in such cases, they usually forget to follow the predefined rules because of the stress and/or are unable to properly act because, for example, of a direct threat from the robbers or because they have to take other urgent actions (escape in case of life threatening, respond to gunfire from the robbers) or they may even be incapacitated/unable to act anymore. Hereafter, such body stress response reaction is referred to as high acute stress.

Attacks also happen during the vehicle trip and mainly in countryside areas, which usually lead to an abnormal driving situation when the vehicle is being chased or forced to stop or tries to escape the attack: all these reactions are a deviation from the normal progress and expected situation or displacement of the conveyor.

Also, it has been found that in many instances, robbery attacks are possible because of an “insider informant”, e.g. because a conveyor is an accomplice and knows that a robbery is going to take place. Indeed, it is typical that the route or path taken by conveyors with a vehicle, and/or its timing, is only known at last moment to avoid the preparation of a robbery on a given route at a given moment. Therefore, when an attack occurs, this is often because somebody informed the attackers of the route and time of the transport, and this person can only be an “insider informant” since such plans a kept secret and communicated at the last moment.

Such an insider informant is expected to show (for example) fear, anticipation, nervousness, guilt prior the attack-minutes, hours or days before the event takes place. Therefore, a change of the daily body stress response patterns of a user can be detected by a combination of continuous measurement/analysis across days and weeks to identify the accomplice in the situation. Hereafter, such body stress response over time is referred as user's stress trends over time.

The publication of Angelica Reyes-Munoz et al: “Integration of Body Sensor Networks and Vehicular Ad-hoc Networks for Traffic Safety”, SENSORS, vol. 16, no. 1, 15 Jan. 2016 (2016-01-15), page 107, XP055394143, DOI: 10.3390/S16010107, discloses a body sensor network to monitor the vital signs of a person which is used to detect four behavior states: drowsy, drunk, driving under emotional state disorders and distracted driving. This prior art refers to the loss of sympathetic nervous system activation and increase of the parasympathetic nervous system, which translates into lowering of connective capacitive and skills to safely drive. Whereas in the present invention, at the moment that the conveyor might be driving, the intended detection refers to a state of sympathetic nervous system activation to enhance the capacity of the conveyor to avoid a robbery—fight or flight response: In times of danger, the body prepares itself to become more aware of its surroundings. Therefore, the intended detections of driver's states are opposite behavior states.’

Similarly to the above mentioned publication, U.S. Pat. No. 10,912,509 discloses a portable intelligent driver's health monitoring system for safety on the road.

US patent publication N° US 2005/0195079 discloses an emergency situation detector for a subject such as a guard, a pilot, fireman. It includes a detection apparatus operated by thresholds to infer the presence of an emergency situation with physiological sensors to detect the stress and also audio inputs, location sensors, and vehicle sensors.

Accordingly, prior art publications disclose the use of stress response inputs or vehicle sensors to identify inadequate driver behavior for traffic safety. Instead, the present invention aims, among other aims, to identify persons that might be driving aggressively in the event that attackers force the vehicle to stop or go out of its route.

The actual situation and technical means to protect from such attacks/robberies and to quickly react to said events are insufficient and there is a need for improved methods and devices in the considered field that allow an attack to be detected in a simple, fast and efficient way.

There is also a need to be able to detect dishonest people such as an insider informant as defined herein.

There is a further need to tailor the system to the users and their daily activities so that it is able to better detect an event, such as an attack occurrence.

### SUMMARY OF THE INVENTION

Accordingly, an aim of the present invention is to improve the methods and means known in the art.

More specifically, an aim of the present invention is to provide methods and means that help conveyors in case of an event such as an attack and that accomplish certain actions automatically without the need of an intervention by the conveyors, for example sending a notification to a control center and data.

Another aim of the present invention is to better detect unusual events or parameters and to be able to take certain actions when such unusual events or parameters are detected.

A further aim of the present invention is to improve the detection process by learning and avoiding errors.

Another aim is to help detect “insider informants” as discussed above, dishonest people from the inside that inform the attackers.

In embodiments, the invention preferably focuses on the detection of a specific event such as an attack detection for valuable goods conveyors.

While body physiological stress response is used as a measurement, in embodiments, the method is used to detect a panic situation in the moment of the attack. The method may use a combination of continuous measurement/analysis (detection of fear/anticipation/nervousness/guilt) of a user also prior to the robbery to identify an accomplice in the situation.

Preferably, in some embodiments, the sensors used in the method according to the invention are all worn by the user(s) (for example the conveyor(s)). In other embodiments, some of the sensors or detectors may be from the conveyor's environment (premises of the company, vehicle, premises of a client, or from the road taken, such as fixed cameras used to control traffic, to read number plates of vehicles, or to control safety in the streets). All such data from sensors may be used to improve the detection method and algorithm.

In some embodiments, personalized/generic monitoring methods to detect the presence of various indicators [events] within a window of time are used in the method. Different events that could happen towards the proximity of the robbery may also be monitored.

For example, in some embodiments, once an event has been detected and recognized (or identified), the system may trigger an alarm at a distant site and/or trigger some other actions on site (sirens, recording of the environment of conveyor, disabling of parts of the vehicle to block the doors in a closed state, stop the engine, mark the notes and other transported goods with ink, glue or other security measures etc.) without the need for specific actions by the conveyors who are the victims of the attack.

An idea of the present invention is to use an algorithm to measure the value of certain parameters and to determine whether the trend of the measured values in time corresponds to normal patterns or not. The values are preferably trends of various indicators over time, for example in last few seconds or minutes before an event, or the duration of certain parameters over time and/or once an event has been detected and/or after the detected event.

In case a value or several values do not correspond to the normal values/ranges/trends/patterns, the algorithm will detect (or identify or recognise) some predetermined abnormal situations which will in turn trigger some predetermined reactions.

In some embodiments, the algorithms may learn over time (for example adapt to the normal values for each user) and be able to better detect abnormal or out-of-the-range values/parameters trend for each user, said values being individual (linked to each user) and not absolute.

The parameters measured are preferably personal parameters of the users, for example conveyors, (such as physical or physiological). One may also add motion parameters (such as for example movement or lack thereof, unexpected acceleration, or linked to the environment: increase of temperature, noises, such as screams, explosions, shocks etc., non-planned route etc.).

On a general level, the attack detection algorithm is based on monitoring certain events (for example a strongly anomalous event called first class indicators or a combination of secondary anomalous events called second class indicators) or a set of certain events happening within a certain time (for example during the last minute). Once the detection has been made, the system triggers a warning a distant control center so that an action may be undertaken immediately and preferably automatically.

“Indicators of attack” are computed to detect anomalous events that have highly probability of occurrence prior and during an attack and correspond to the above-mentioned values or parameters. Such indicators are for example (non-limitative list): high acute stress (i. e. extreme reaction of panic or fear) detection by an increase in heart-beat interval variability, cardiovascular markers on the pulse wave, skin and body core temperature, respiration rate, skin conductance response and sweating level; harsh driving, sudden stop that is classified as a suspect stop based on historical geo-localization (out of known-safe areas) by body motion and user's localization; vehicles out of normal routes, noise, shocks etc. Many other indicators are possible within the frame of the present invention to detect an abnormality over normal (or expected) values ranges or trends on the user or his/her surroundings. Also, the parameters indicated above to detect high acute stress may be used alone as indicators of an attack or of another event to be detected, depending on the application in which the method according to the invention is used.

“Indicators of attack” may also be used to detect that an attack is going to happen. Physiological parameters as mentioned herein may be different when a subject knows a robbery is going to take place so they may help improve the security by generating some specific actions in anticipation to prevent the robbery: additional plane changes, cancelling of a transport, change of route or timing, scouting of the planned route with environment detectors to detect abnormal presences or obstacles etc.

Features and embodiments of the present invention are detailed in the following description thereof and in the appended claims.

Although the present description relates mainly about the attack detection of conveyors transporting goods of value, the invention is not limited to this application and its principles are applicable to other applications where personal parameters (linked to a person or a user) and external parameters (linked to a the user's environment) are analyzed by algorithms in order to detect certain events or situations related to the user.

For example, high acute stress detection: a general application is to measure the acute stress level of a person, and detect if there's a risk to the proper accomplishment of a given task, mainly for critical tasks such as:
—) First responders (medics) where human lives are at stake;
—) Medical doctors, for example before a surgery or in an emergency room;
—) Police: for example during an operation or a pursuit;
—) Firefighters, in case of fire or of an emergency involving chemicals etc.;
—) Airplane pilots (for example commercial flights or military flights);
—) Race pilots (for example car racing);
—) Soldiers (for example during drill or combat operations);
—) Astronauts (for example when training or during a real mission);
—) Logistics: for example a worker driving a vehicle containing goods, that might feel bad or try to steal the merchandise.

Abnormal driving or movement detection: a general application is to assess any abnormality in the driving of a given user (too slow, too fast, weird, unusual, or incorrect trajectories, . . . ) or in the movement of a person, which could impact the success of a task.

Attack detection (based on high acute stress; abnormal driving detection; unknown stops and routing):
—) Transport of valuable goods;
—) Prisoner transport;
—) VIP transport;
—) Hijacking of a vehicle (for example an airplane).

All these applications are examples and should not be considered limiting. Other equivalent applications are possible within the frame of the present invention.

In embodiments, the invention concerns a method for detecting an event or a situation happening around of at least a user, for example a valuable goods conveyor, wherein said method comprises the steps of
—) measuring values of personal parameters linked to the user body and/or of environmental parameters linked to the environment of the user,
—) analyzing the values obtained by the measurement step with respect to patterns, trends and/or ranges of values in/over time, which may be predetermined or not;
—) depending on the result of the analysis, determining whether the measured values correspond to a predetermined indicator or predetermined indicators of an event;
wherein said indicator(s) comprise(s) at least a first-class indicator indicating high probability of the occurrence of the event and/or a second-class indicator indicating lower probability of the occurrence of the event.

In embodiments, a predetermined first event recognition (or identification) may be triggered by the detection of at least one first class indicator of the event.

In embodiments, then a predetermined primary event reaction may be triggered once, at least, one first class indicator has been detected by the algorithm. The reaction may be of several types, depending for example on the application. It may be an alarm for example.

In embodiments, a predetermined second event recognition (or identification) may be triggered by the detection of at least two second class indicators. The reaction may be of several types, depending for example on the application. It may be an alarm for example.

In embodiments, the event recognition (or identification) may be triggered by the detection of at least a first-class indicator and second-class indicator.

In embodiments, the detection may be carried out over a certain period of time to measure trends for example.

In embodiments, a predetermined event recognition (or identification) may be an attack occurrence.

In embodiments, first class indicators may comprise high acute stress, sustained high acute stress, high driving speed, harsh braking, harsh driving, abnormal stop, out-of-normal routes, specific sounds, man down, and bullet impacts

In embodiments, second class indicators may comprise sustained acute stress, unknown stop, abnormal driving state, abnormal speed state, unusual body movements.

In embodiments, the user is preferably a conveyor.

In embodiments, values are measured by sensors as disclosed in the present application.

In embodiments, the method may comprise a learning phase during which phase personal parameters of users are monitored during a certain time, so that the method may be adapted to each user and its daily activity pattern.

In embodiments, the learning phase may be carried out on a permanent basis or at intervals (regular or not) as described hereunder.

In embodiments, the method measures and analyses the parameters to detect abnormal behaviors by the users, for example “insider informants”. In such case, some parameters may be abnormal before an attack because the user, as an insider informant, is aware of the fact that an attack will take place. The reactions to the event will therefore be different between a user aware that a robbery will take place and a user who is unaware that the robbery will take place.

In embodiments, a combination of continuous measurement/analysis across days and weeks a change of the patterns of a user can be detected to identify an accomplice.

In embodiments, the measurement of values of personal parameters may be used to anticipate an the occurrence of the event/situation or for forensic analysis, for example after an attack has taken place, to determine if there was an insider informant or to learn from a real situation.

In embodiments, a predetermined reaction may be triggered depending on the result of the analysis by the algorithm: such as an attack alarm or another notification of event.

### BRIEF DESCRIPTION OF THE DRAWINGS

FIG. 1 illustrates a general architecture of an embodiment of the method according to the present invention;

FIGS. 2A to 2H embodiments of the functioning of the method according to the present invention.

### DETAILED DESCRIPTION

In some embodiments, the method according to the invention is an attack detection solution with the following features.

It comprises and uses sensors to detect certain parameters, but not limited to the following list:
—) accelerometers, Gyroscope, Magnetometers (person activity level detections, and abnormal driving events detection);
—) ECG/PPG (heart rate variability detection);
—) skin temperature sensors;
—) body core temperature sensors;
—) skin conductance sensors (body sympathetic activation detection and sweating levels detection);
—) respiration sensors (respiration rate detection);
—) GPS sensors (localization, route detection, speed);
—) speed sensors;
—) sound sensors;
—) shock sensors;
—) person activity type recognition sensors, such as moving, running, jumping etc.;
—) person physical activity level sensors, such as moving fast, running fast etc.;
—) sensors able to detect the information of the user's surroundings (vehicle sensors, indoor location, sound, temperature, street cameras and/or security cameras, weather information.);
—) cameras, for example for real-time video recognition of weapons;
—) radiation sensors;
—) gas composition.

Preferably, the method according to the invention uses sensors mainly placed on the user(s) who is (are) as the main source of information. In some embodiments, sensors are also placed on the user's environment.

The sensors generate data and have timestamps. Sensors comprise (but are not limited to) sensor devices that detect directly a parameter and methods/detectors that process directly the measured data of the parameter to determine an indirectly detected parameter. Sensor devices may comprise batteries and communication means (wire or wireless)

These are only examples of possible sensors and measured parameters and many other sensors/parameters may be used to provide useful information for embodiments of the present invention, for example depending on the application.

Methods according to embodiments of the present invention are described in more detail hereunder.

In an embodiment, in order to assess whether an attack event occurs, embodiments the method according to the invention may consider two types of parameters, namely:

“Indicators of attack” which are strongly indicative of an anomalous event (in the following description referred to as “first-class indicator(s)”)

And “abnormal state(s)”, which define a lower probability of attack occurrence because they are not as strongly indicative of an anomalous event (such as an attack) as referred to as “second-class indicators”. However, in some instances, such abnormal state(s) may be the indicator of an attack, for example if they last for a certain time, or if certain abnormal states occur at the same time or close to each other, or in a certain order. Therefore, a combination of second-class indicators may indicate the presence of an attack as well.

Other classes (third etc.) of indicators may be defined depending on the application of the method according to the invention for other indicators and/or states.

In embodiments of the present invention, these indicator(s) and abnormal state(s) allow to determine and/or evaluate a level of abnormality related to a specific concept for a specific timeframe and to identify the probability of predetermined event occurrence. Then, as a reaction this result, the system/method chooses the appropriate predetermined event notification that is to be carried out after said determination/evaluation of a situation.

In embodiments of the invention, attack indicators include (but are not limited to):

### Personal/User Physiological-Linked

“High acute stress” indicator: which for example uses information of the last 90 seconds (or less) of heart rate variability and body physical activity level data. The detection time frame may be less than 90 seconds or more that 90 seconds, this value being non-limiting but only an example. The time frame may be different for different people for example. Other physiological sensors may also be used for a more accurate stress detection.

“Sustained acute stress” indicator: which for example uses information of the last 90 seconds of heart rate variability and body physical activity level data, is activated after 50+ seconds of active acute stress status. Again, the time values are examples and other values may be used in some embodiments. They may also be adapted to the person/user.

Typically, the indicators linked to the person/user (such as a conveyor) may be standardized with the same values or ranges (e.g. mean heart rate or specific range, idem for skin temperature or skin conductance, applicable to all indicators measured on a person) or they may be personalized to consider the physical and physiological specifics of a person: a user may for example have a lower heart rate than another user so the parameters must be adapted to each user in order to be relevant and to be able to detect indicators or abnormal states on the basis of the measured values.

In some embodiments, a learning phase may be implemented so that the system may measure the desired values/parameters and trends of a user and of all information sources and keep these values for future use when the user is effectively working, for example as a conveyor transporting money, valuable goods and/or bank notes. The learning phase may be carried out once at the beginning of employment, or on a regular basis (for example at predetermined intervals) to take account of changes on the side of the user, such as aging, improvement in physical condition such as intensive sports training or, conversely deterioration in physical condition due to an illness, smoking, lack of sleep etc. The learning phase may also be implemented on a permanent basis so that the system is able to take account of the immediate physical state of a person, for example, fitness (or lack of fitness) of the person. Such systems are for example used in the field of sports (for example marathon running) where the training for a set objective is adapted every day to the user by considering his/her actual state and fitness (for example: too much training gives an instruction to rest, while lack of training gives an instruction to increase training, determined by the decided goal to be achieved the user). A real-time adaptation of the system may accordingly be achieved thus improving the efficiency of the method in all applications.

The learning phase may also be improved by submitting the users (for example conveyors) to exercises: for example simulations of attacks, intensive drive training sessions and other specific exercises linked to the application while wearing the sensors. The values measured may then also be used to improve the system and methods and adapt them to the users.

These learning phases principles are of course applicable to the other applications possible with the method according to the present invention and is adaptable to take account of the specific application envisaged and the parameters, indicators and data relevant for the specific application.

### User Motion-Linked (or Environment-Linked)

“High driving speed”: for example, 80% of the speed values (derived of the GPS sensor) are over 140 km/h in the last 10 seconds, or based on the speed limit of the area (e.g. over said limit). Again, these are exemplary values and they may be adapted to the case, route chosen etc. For example, the mere detection that the vehicle is over a certain speed limit could be sufficient to trigger an alarm.

“Harsh braking”: for this parameter, one may use acceleration data measurements from the user to detect unusual braking actions.

“Harsh driving”: for this parameter, one may use acceleration, gyroscope and speed data and it may be triggered by more than 3 abnormal driving events happening in the last minute, such as fast turns, high accelerations and high speed. All values are examples and should not be regarded as limiting the scope and they may be adapted to the route of the vehicle: i.e. driving on a mountain road (with many bends and braking) should not be considered harsh driving whereas when this happens on a normal straight and flat road then it should trigger an alarm. All sensors are worn by the user, and therefore a learning phase is needed to adjust the detection methods to the user body movement in combination with the vehicle type.

“Environment”: sounds, such as explosions, shocks etc. on the vehicle may be detected as well and used to trigger an alarm. Also street cameras may be used to detect the passage of a vehicle on a wrong street, wrong direction or at an abnormal speed.

These are only exemplary embodiments and other parameters and/or indicators and data may be detected and used in the method of the present invention, for example depending on the vehicle used by the user a learning phase will be need to filter user's movement from vehicle ones (truck, car, airplane).

In embodiments of the method, considering the above indicators, an attack is detected when:
Two or more active indicators of attack are detected and/or
A sustained high acute stress is detected for more than a certain time, for example 30 seconds.

Of course, these are only examples and an attack detection may be done by only one indicator or by the level of the detected indicator or by a parameter of an indicator: e.g. in some circumstances or applications, some indicators (or parameters thereof) may be considered enough as such and sufficient on their own to detect an attack or an anomalous event. Or the value detected may be so far away from predetermined normal values and/or ranges that this also is sufficient to trigger an event detection. Accordingly, for each indicator and/or parameter, one may decide on its cruciality (allowed to trigger an event detection on its own or not) and on the level of difference that requires a second indicator to be detected or the detected level sufficient to trigger an event detection with a single indicator.

In embodiments of the invention, abnormal states may comprise:
“Sustained acute stress” activated for 30+ seconds.
“acute stress plus”: low stress plus another abnormal state
“Abnormal stop”: a stop that is not normal
“Stop plus”, a stop with another abnormal state
“Abnormal driving state”: any abnormal driving event before the harsh driving indicator is active
“Abnormal speed state”: abnormal high driving speed indicator sustained for a certain duration before the high driving speed indictor is activated.

In embodiments of the present invention, any combination of indicators may be used to define a predetermined output of the system, such as an event detection (and the subsequent reaction, for example an alarm). The system may therefore be parametrized as desired by the user. For example, for an abnormal state to trigger the event of “attack”, one of the following conditions must be met:
1) A first-class indicator
2) Several second-class indicators such as two concurring abnormal states plus high acute stress detection or two abnormal states plus a suspicious stop.

In other embodiments, other conditions or combinations may be defined to trigger the “attack” identification (or recognition) and/or an action either locally or a at distant site, for example as illustrated in the drawings 2A to 2H.

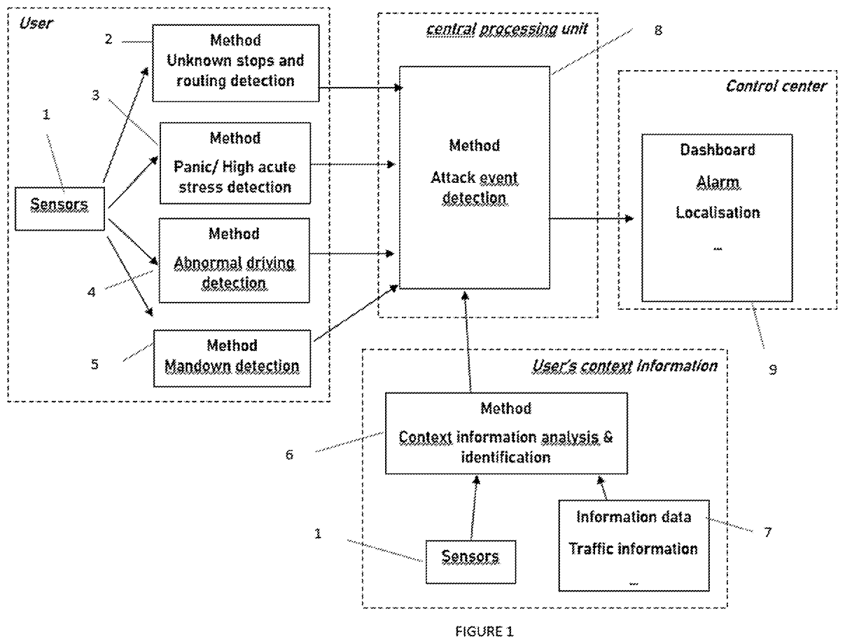

In FIG. 1 an architecture of the system and method according to an embodiment of the present invention is illustrated.

It comprises a block 1 illustrating the sensors used in the application (on the user or for the context). As listed above in the present description, the sensors may measure parameters/values linked to the person (i.e. heart rate, skin temperature) and/or to the environment (i.e. GPS, acceleration, movements, noises). These values are respectively fed to algorithms (boxes 2-6) that carry out the treatment of said values and detect, for example, a stress during a certain time (linked to the person) and abnormal driving (linked to the environment). These detection values are then fed to an algorithm (box 8) that carry out the analysis to detect an event, for example an attack in this embodiment. The analysis algorithm may also be fed with other information data, for example traffic information (or about works on the road, speed limits, stop areas, train crossings, box 7) that may be used to confirm or infirm the abnormal driving detection.

The algorithm then sends the result of the analysis to a dashboard or screen 9 with the predetermined reaction, such as for example an alarm, and/or a localization which can be shown on the dashboard 9 etc. The alarm may be a visual alarm and/or a sound alarm at the Control center. The alarm may different depending on the situation and/or event detected. The alarm may also be transferred to other people such as a rescue services (such as police). This transfer may be direct or after an evaluation at the Control center (for example to confirm the attack). Of course, depending on the application (medical staff, firefighters, pilots etc.), the alarm may be sent to other people/services as predetermined in said application. The dashboard may show any predetermined information, such as localization of the user(s), real-time movies and sounds of the environment where the user is located (from cameras placed in the vehicle or worn by the users), that is useful for the Control center to assess the situation and take appropriate and/or predetermined measures corresponding to the alarm.

As will be readily understood, the system and method according to the invention may be adapted to the application with the necessary parameters, algorithms, information data and the result shown on the dashboard. The algorithms may be running in concrete devices (for example computers) which are placed locally on the users (dedicated devices, smart devices such as smartphones or smartwatches) and/or in a physical control center, or in the cloud. Some algorithms (or parts thereof) may be running locally (see for example boxes 2-6) and others may be in the system's central processing unit (see box 8) that might be hosted in the cloud or in a physical control center.

For communicating, the different parts of the system may use: hard wires or wireless technology with antennas, optical means, audio means (sound recording and generating) etc.

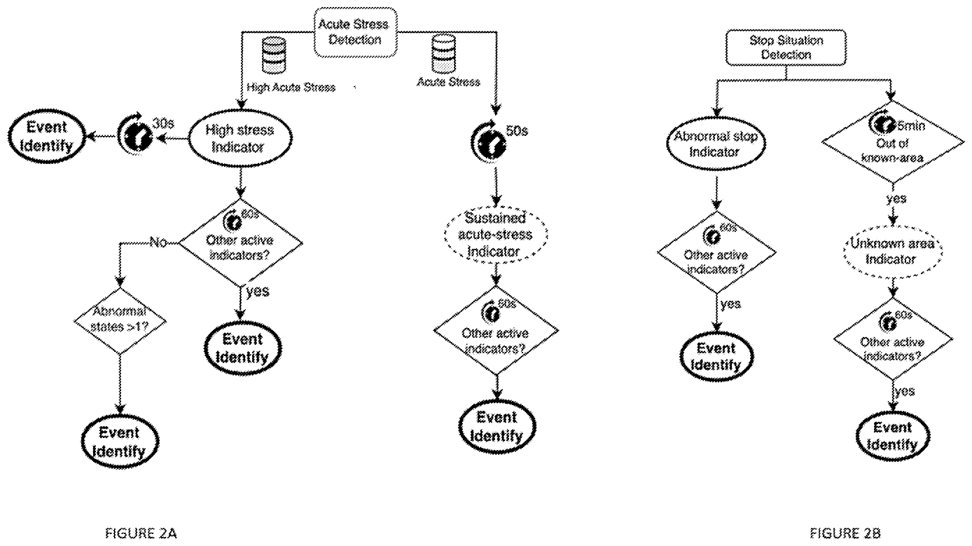

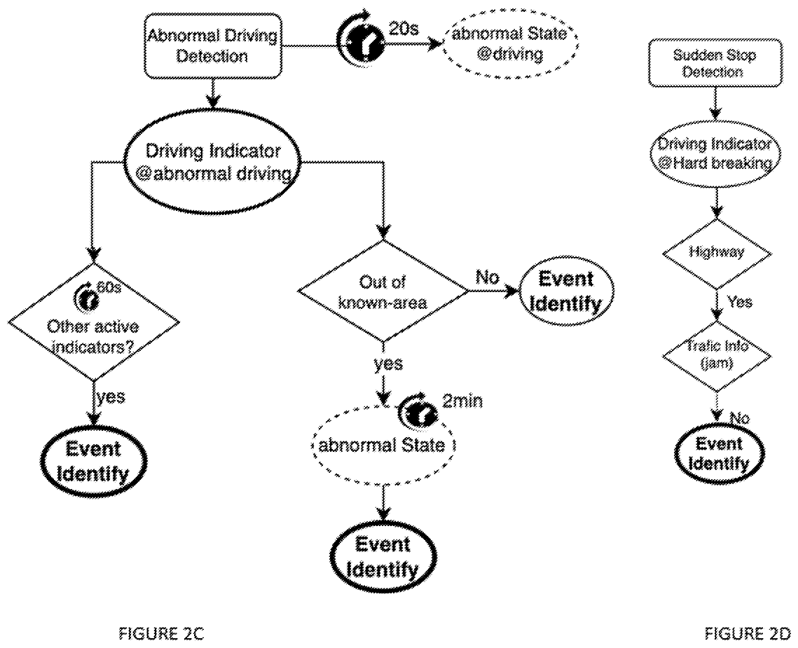

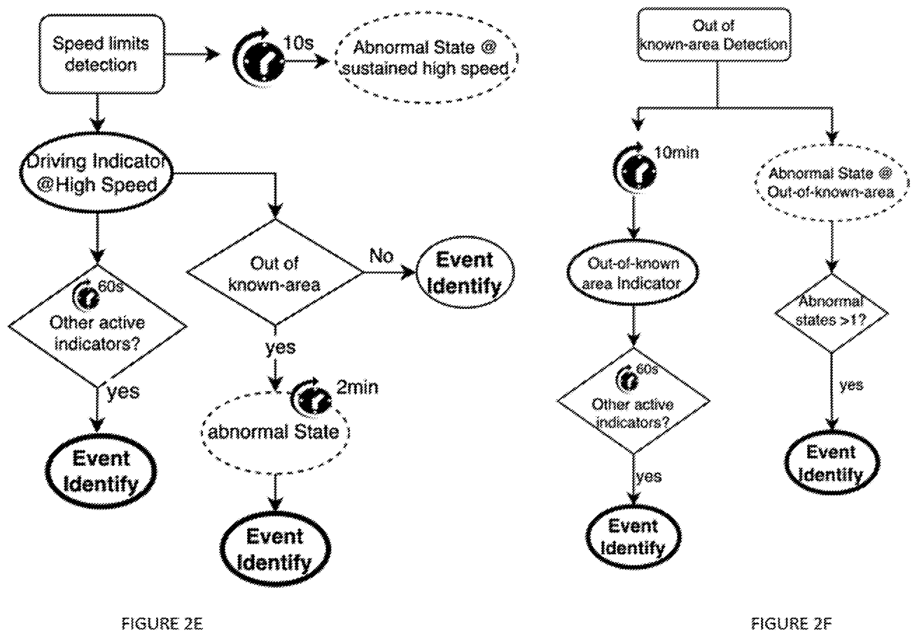

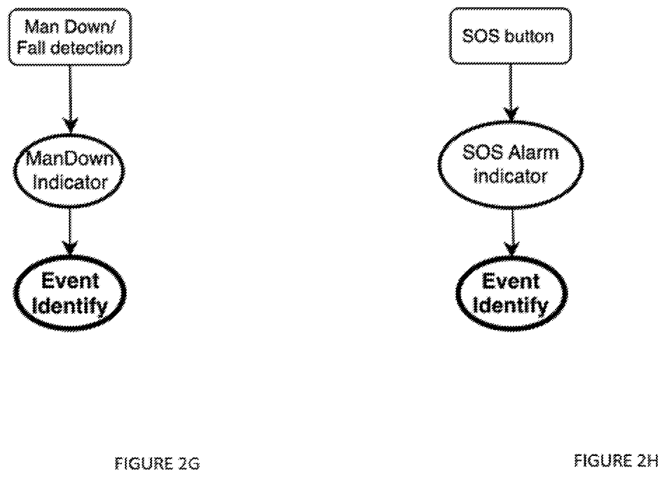

FIGS. 2A to 2H illustrate examples of the functioning of the method according to embodiments of the present invention.

For example in FIG. 2A, the stress is measured (see sensor 1 and box 3 in FIG. 1) and it can be a high acute stress level or a acute stress as illustrated in FIG. 2A. The corresponding signal is fed in the attack detection algorithm (box 8) which generates a high stress indicator, for example a first-class indicator. The attack detection analyses whether this indicator remains for a certain time (for example 30s as illustrated) then the attack detection algorithm (box 8) issues an event identification (also referred to as an event recognition) signal (such as “Attack”). While the high stress indicator has been generated, the algorithm also checks whether other indicators are active (for example second class indicators). If this is the case, an event identification signal (such as “Attack”) is issued by the attack detection algorithm. If this is not the case, then a further test is made to check whether an abnormal state is detected (for example a second-class indicator, or a subsequent state indicator) and if this the case, an event identification signal (such as “Attack”) is issued by the attack detection algorithm.

In the other branch (“acute stress”), if the acute stress detection is maintained for this time (for example for 50s), then a signal of “Sustained acute stress indicator” is generated. If another indicator is (or has been) detected, then the event identification signal is issued by the attack detection algorithm (such as “Attack”).

FIG. 2B illustrates an embodiment of the method when an indicator of stop situation is determined (for example box 4). The algorithm controls if this is an abnormal stop indicator and if yes, if other predetermined indicators are active.

If this is the case, an event identification signal (such as “Attack”) is issued by the attack detection algorithm (box 8). In parallel, another control is made by the algorithm if the stop situation happens in out of known areas, and if his situation is maintained after a certain time (for example 5 minute) and if another indicator is active, an event identification signal (such as “Attack”) is issued by the attack detection algorithm (box 8).

FIG. 2C illustrates another embodiment of the present invention in case of an abnormal driving indicator. The algorithm (box 4) sends a signal of abnormal driving and if this indicator does not change after certain time (for example for 20s). The algorithm of attack detection (box 8), once it has received the signal corresponding to this indicator, controls whether other indicators are active (for example during 60 seconds) and if the test is positive it issues an event identification signal (such as “Attack”).

The algorithm also controls whether an indicator of out of known area is present and if not, it issues a warning. If this indicator maintained in time (for example for 2 minutes), an event identification signal (such as “Attack”) is issued by the attack detection algorithm.

FIG. 2D illustrates an embodiment of the present invention with a sudden stop indicator (box 2). In that case the attack detection algorithm considers the road on which the truck is moving and if it is a highway, the algorithm considers an outside information data (box 7), in this case the presence of a traffic problem (for example a traffic jam) which could be the reason for the sudden stop. If there is no traffic jam (or another reason to stop on a highway) an event identification signal (such as “Attack”) is issued by the attack detection algorithm (box 8).

FIG. 2E illustrates another embodiment of the present invention with a speed limit indicator. The algorithm (box 4) sends a signal of high speed if an over the speed limit indicator is detected and if this indicator does not change after certain time (for example for 10s), an abnormal state of sustained high speed is triggered.

Also, the algorithm of attack detection (box 8), once it has received the signal corresponding to this indicator, controls whether other indicators are active (for example during 60 seconds) and if the test is positive it issues an event identification signal (such as “Attack”).

The algorithm also controls whether out of known area indicators are present and if not, it issues an event identification, in this case a secondary class predetermined event. If this indicator is present for certain time (for example for 2 minutes), an event identification signal (such as “Attack”) is issued by the attack detection algorithm.

FIG. 2F illustrates another embodiment of the present invention with an out of known area indicator. If an out of known area indicator is detected (box 2), the algorithm of attack detection (box 8), once it has received the signal corresponding to this abnormal state, analyze in time (for example for 10 minutes) if this abnormal state remains, it controls whether other indicators are active (for example for 60 seconds): for example a stress indicator. If the stress indicator is present, the attack detection algorithm issues an event identification signal (such as “Attack”). In parallel, the algorithm of attack detection controls the indicator of out of known area, and an abnormal state is present, then the algorithm of attack detection issues directly an event identification signal (such as “Attack”).

FIG. 2G illustrates another embodiment of the present invention with a man down/fall indicator (box 5). If this indicator is detected the attack detection algorithm issues a “man down alarm” as identified second class event. The attack detection algorithm also controls if another alarm is active (for example another indicator). If this is the case, then it issues an event identification signal (such as “Attack”).

FIG. 2H illustrates another embodiment of the present invention with a SOS button indicator. If this indicator is detected the attack detection algorithm issues a SOS alarm as identified secondary event. The attack detection algorithm also controls if another alarm is active (for example another indicator). If this is the case, then the attack detection algorithm (box 8) issues an event identification signal (such as “Attack”).

Of course, the event identification signal may be different, for example it may depend from the application of the method and system.

The above scenarios of attack detections are examples of applications and functioning of the method according to the present invention and should not be construed in a limiting manner. Many combinations of such scenarios are possible, also for other applications as indicated above in the present description with other parameters and indicators relevant for the chosen application, the principles of the present invention as described herein being applicable to such parameters and indicators.

The present description is neither intended nor should it be construed as being representative of the full extent and scope of the present invention. The present invention is set forth in various levels of detail herein as well as in the attached drawings and in the detailed description of the invention and no limitation as to the scope of the present invention is intended by either the inclusion or non-inclusion of elements, components, etc. Additional aspects of the present invention have become more readily apparent from the detailed description, particularly when taken together with the drawings.

Moreover, exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined not solely by the claims. The features illustrated or described in connection with an exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein with respect to embodiments of the present invention, the scope of the present invention is not so limited. Moreover, while this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A method for detecting an event or a situation happening near at least a user, wherein said method comprises the steps of
measuring values of personal parameters linked to the user body and/or of environmental parameters linked to the environment of the user,
analyzing the values obtained by the measurement step with respect to trends of values in time,
depending on the result of the analysis, determining whether the measured values correspond to a predetermined indicator or indicators of an attack;
wherein said indicator(s) comprise(s) at least a first-class indicator indicating high probability of attack and a second-class indicator indicating lower probability of attack.

2. The method of claim 1, wherein a predetermined first reaction is triggered by the detection of at least one first class indicator of the event.

3. The method of claim 1, wherein a predetermined second reaction is triggered by the detection of at least two second class indicators.

4. The method of claim 1, wherein the detection is carried out over a certain period of time spanning over minutes, hours, or days.

5. (canceled)

6. The method of claim 1, wherein said first class indicators comprise high acute stress, sustained high acute stress, -high driving speed, harsh braking, harsh driving, abnormal stop, out-of-normal routes, specific sounds, man-down detection, and bullet impacts.

7. The method of claim 1, wherein second-class indicators comprise sustained acute stress, unknown stop, abnormal driving state, abnormal speed state, unusual body movements.

8. The method of claim 1, wherein the user is a conveyor.

9. The method of claim 1, wherein said values are measured by sensors worn by the conveyor comprising
accelerometers, Gyroscope, Magnetometers, person-activity level detections, and abnormal driving events detection;
ECG/PPG;
skin temperature sensors;
body core temperature sensors;
skin conductance sensors;
respiration sensors;
GPS sensors;
speed sensors;
sound sensors;
shock sensors;
person activity type recognition sensors;
person physical activity level sensors;
sensors able to detect the behavior of the user's surroundings;
cameras;
radiation sensors;
gas composition sensors.

10. The method of claim 1, wherein said method comprises a learning phase during which phase personal parameters of users are monitored during a certain time, so that the method may be adapted to each user and its daily activity pattern.

11. The method of claim 9, wherein said learning phase is carried out on a permanent basis, regular basis or irregular basis.

12. The method of claim 1, wherein the measurement of values of personal parameters are used to anticipate an the occurrence of the event/situation or for forensic analysis.

13. The method of claim 1, wherein a predetermined reaction is triggered depending on the result of the analysis.
